(19) United States
(12) Patent Application Publication
(10) Pub. No.: US 2025/0118740 A1
(43) Pub. Date: Apr. 10, 2025

(54) SILICON ANODE FOR LITHIUM-ION BATTERIES, AND METHOD FOR PRODUCING SAME

(71) Applicant: NORCSI GMBH, Halle (DE)

(72) Inventors: Udo REICHMANN, Wilsdruff (DE); Andreas KRAUSE-BADER, Dresden (DE); Marcel NEUBERT, Kreischa (DE); Sahar LAUSCH, Halle (DE)

(73) Assignee: NORCSI GMBH, Halle (DE)

(21) Appl. No.: 18/722,388

(22) PCT Filed: Dec. 20, 2022
(86) PCT No.: PCT/EP2022/086925

§ 371 Date: Jun. 20, 2024

(30) Foreign Application Priority Data
Dec. 23, 2021 (DE) 10 2021 134 516.2

(51) Int. Cl. H01M 4/38; H01M 4/02; H01M 4/04; H01M 4/134; H01M 4/66; H01M 10/0525

(52) U.S. Cl. CPC H01M 4/386; H01M 4/0426; H01M 4/0471; H01M 4/134; H01M 4/661; H01M 10/0525; H01M 2004/021; H01M 2004/027

(57) ABSTRACT

A method for producing a silicon anode for lithium batteries, wherein an active layer made of silicon is deposited onto a substrate, preferably copper, said active layer then being subjected to a rapid annealing process. The aim of the invention is to provide a method with which the stress in the deposited layers for producing a silicon anode for lithium batteries can be minimized and which can be easily integrated into an existing production process. This is achieved in that a substrate surface is structured by means of a process prior to applying the active layer, the substrate surface is modified in an unstructured state by means of a process, or the active layer is structured during the production thereof by means of photolithography and a subsequent physical deposition process, preferably sputtering or vapor deposition, and an annealing process, preferably a rapid annealing process, so as to form segments.

The invention relates to a plurality of methods for producing a silicon anode for lithium batteries, wherein an active layer made of silicon is deposited on a substrate, preferably copper, the active layer subsequently being subjected to rapid thermal annealing.

The invention also relates to the use of the methods according to the invention for the production of a silicon anode in a lithium-ion battery, to the silicon anode as such and to the use of the silicon anode in a battery cell and in a lithium-ion battery.

Batteries are electrochemical energy stores and are differentiated as primary batteries and secondary batteries.

Primary batteries are electrochemical power sources in which chemical energy is irreversibly converted into electrical energy. Therefore, a primary battery cannot be recharged. In contrast, secondary batteries, also called accumulators, are rechargeable electrochemical energy stores in which the chemical reaction that occurs can be reversed, so that repeated use is possible. During charging, electrical energy is converted into chemical energy, whereas during discharging, chemical energy is converted into electrical energy.

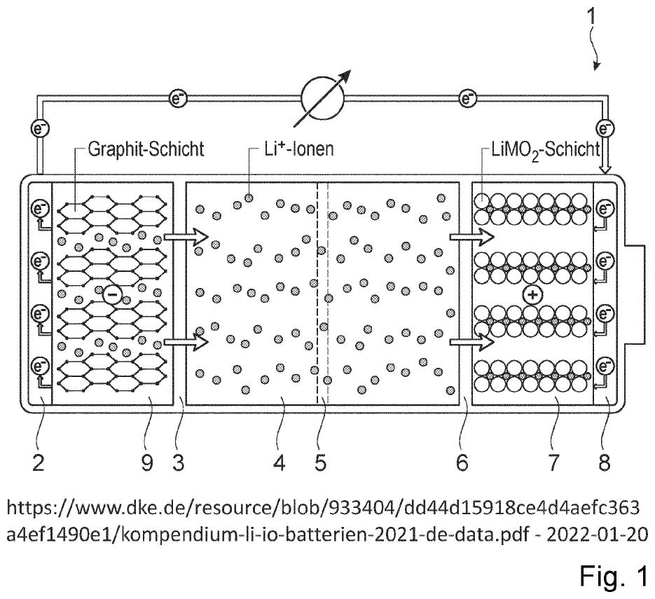

The term “battery” is the general term for interconnected cells. Cells are galvanic units that consist of two electrodes, electrolyte, separator, and cell housing. FIG. 1 shows an exemplary construction and the function of a lithium-ion cell during the discharging process. The components of a cell are briefly explained below.

Each Li ion cell consists of two different electrodes: an electrode which, in the charged state, is negatively charged and an electrode which, in the charged state, is positively charged. Since during energy release, i.e. during discharging, ions migrate from the negatively charged electrode to the positively charged electrode, the positively charged electrode is called the cathode and the negatively charged electrode is called the anode. The electrodes are each composed of a charge collector (also called a collector) and an active material applied thereto. Between the electrodes there are the ion-conducting electrolyte, which enables the necessary charge exchange, and the separator, which ensures the electrical isolation of the electrodes.

The cathode is composed of, for example, mixed oxides, which are applied to an aluminum collector.

The anode of an Li ion cell can consist of a copper foil as a collector and a layer of carbon or silicon as an active material. During the charging process, lithium ions are reduced and are intercalated into the graphite layers or silicon layers.

Silicon as the active material for the anode has a high storage capacity of approximately 3579 mAh/g for the Li₁₅Si₄ phase at room temperature, in comparison with the conventional carbon-type materials, such as graphite with a storage capacity of 372 mAh/g.

The capacity of the battery is determined by the thickness of the active layer, more precisely the Si layer. The electrical conductivity of the active material should be set as high as possible in a battery. Silicon, as a semiconductor, is only poorly conductive, in contrast to conductive graphite. Therefore, silicon needs high doping or structures that increase the electrical conductivity.

When the electrode material used is silicon, there are challenges with respect to the sometimes considerable volume change (volume contraction and volume expansion) of the host matrix during the intercalation and deintercalation of the mobile ion species (lithium) during charging and discharging of corresponding energy stores. The volume change is approximately 10% for graphite, while it is approximately 400% for silicon. The volume change of the electrode material when silicon is used leads to internal stresses, crack formation, pulverization of the active material of the host matrix (silicon) and, finally, complete destruction of the electrode.

Previous active materials are typically applied to the copper foil in the form of particles in a binder layer and dried. The process is stress-free, since here the active material is fixed on the current collector by means of a flexible adhesive. The flexible adhesive compensates for the stress on the current collector when there is volume expansion of the active material during battery operation and ensures permanent electrical contact. If flexibility is not ensured, the active material is pulverized, the power contact is lost and the capacity of the battery is reduced. As a result of the use of the adhesive as an inactive component of the active material, the energy density is reduced.

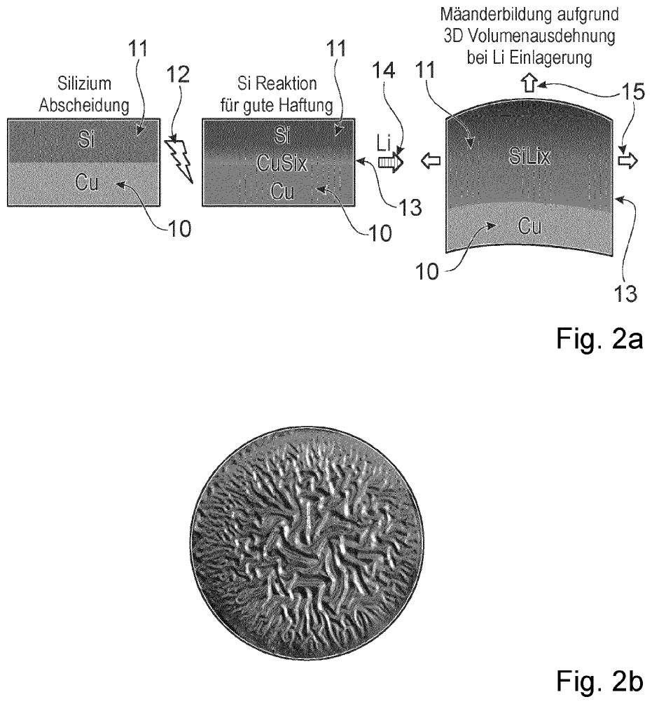

The adhesion of the active layer can be improved by using rapid thermal annealing. The term “rapid thermal annealing” is understood to mean, in particular, flash lamp annealing and/or laser annealing. Flash lamp annealing is performed with a pulse duration or annealing time in the range of 0.3 to 20 ms and with a pulse energy in the range of 0.3 to 100 J/cm². In laser annealing, the annealing time is set from 0.01 to 100 ms by the scanning speed of the local heating point in order to produce an energy density of 0.1 to 100 J/cm². The heating ramps achieved in rapid thermal annealing lie in the range necessary for the in the method of 10\hat{ }4-10\hat{ }7 K/s. Flash lamp annealing uses a spectrum in the visible wavelength range for this purpose, whereas, in laser annealing, discrete wavelengths in the region of the infrared (IR) to ultraviolet (UV) spectrum are used. If an active layer of silicon is deposited on a substrate, preferably copper, said active layer subsequently being subjected to rapid thermal annealing, this produces very strong adhesion of the silicon to the copper foil that has not been previously observed in the case of conventionally produced anodes. While, as a result of the volume expansion/shrinkage, it is normally the case during battery operation that the active material either is retained on the current collector by means of flexible adhesive or is simply pulverized, this is not the case for anodes produced by means of rapid thermal annealing. However, the strong adhesion leads to warping of the substrate, i.e. the current collector, during battery operation, this being shown by a distinct meander structure (waviness of the ply structure) in the side view of the layer stack (see FIG. 2).

Therefore, another challenge is that, when anodes are produced on planar foil substrates, foils coated on one side in such a way exhibit a curvature toward the foil or toward the coated side, depending on the stack construction, after production. The cause is internal stress of the layer formed after deposition and annealing. This makes the manufacturing of batteries more difficult, because they must typically be constructed from various plies of stacked foils/layers. The term “ply” is understood to mean the different layers of a layer construction or layer stack of an Si electrode. The terms “ply” and “layer” are used synonymously in this application. Mechanical force for planarization is necessary and therefore the curvature is a hindrance in the manufacturing.

Applying layers in vacuum processes or temperature processes causes internal stresses to build up as a result of different expansion coefficients and densities of the layers and substrates. As a result of strong adhesion of the layers formed to the substrate or the current collector, especially due to the use of rapid thermal annealing, this leads to warping of the copper foil, and said warping hinders processing and operation as an anode.

These stresses can be adjusted by means of the process, by changes in the process parameters, such as pressure, gas, substrate temperature, power, layer material, reaction, etc. In this way, compressive and tensile stresses of the layer can be combined in order to produce a relaxed layer in the end. This requires precise adjustment of stress management to exactly one production process and must be repeated for slight variations. Coating both sides of the foil is possible but leads to an even more highly stressed overall foil which can tear during battery operation.

Therefore, the object of the present invention is to provide methods by means of which the stress in the deposited layers for producing a silicon anode for lithium batteries can be minimized. The methods should be easy to integrate into an existing production process and should allow precise control of stress management in the deposited layers of the anode construction.

The object is achieved by a first method as claimed in independent claim 1. The method for producing a silicon anode for lithium batteries, in which method an active layer of silicon is deposited on a substrate, preferably copper, said active layer subsequently being subjected to rapid thermal annealing, a substrate surface of the substrate is structured by means of a process before the active layer is applied.

In one embodiment of the method according to the invention, the substrate surface is structured by means of a laser.

In another embodiment of the method according to the invention, the substrate surface can be structured by means of embossing, rolling or stamp, thereby creating height variations in the range of up to 20 μm. The structuring is carried out before additional layers are deposited on or applied to the substrate surface.

In a further embodiment of the method according to the invention, the substrate surface is structured by means of photolithography and subsequent physical deposition, preferably by sputtering or evaporation.

The structuring of the surface of the substrate is a technical means of simplifying stress management, thereby creating separated segments which are not connected to one another two-dimensionally. By means of microscopic structuring, the stress of the layer is interrupted in individual segments. As a result, processing of the foils/the substrate after production is greatly simplified. The structuring additionally leads to controlled reduction of the meander structure during battery operation, and this greatly reduces microscopic detachment of active material. If the structuring is fine enough, i.e <10 μm, preferably between 1 μm and 5 μm, the segmenting resulting from the structuring can additionally compensate for the volume expansion of the active material during lithium intercalation, without pulverization of the active material. Produced ply structures described in the literature exhibit a size of the cracks of the fractured layer on the order of magnitude of micrometers when amorphous silicon is used. Precise control of the cracks is possible with the method according to the invention.

Ordered structuring by means of a laser, or embossing, rolling or stamping is particularly suitable for large-scale production.

The object is also achieved by a second method as claimed in independent claim 5. The method for producing a silicon anode for lithium batteries, in which method an active layer of silicon is deposited on a substrate, preferably copper, said active layer subsequently being subjected to rapid thermal annealing, the substrate surface and/or the active layer is modified in an unstructured way by means of a process.

An unstructured modified surface is understood to be a roughened surface, where there are likewise separated segments of the surface which are not connected two-dimensionally to one another.

In one embodiment of the method according to the invention, the unstructured modification is carried out by means of rapid thermal annealing or by means of etching or by means of chemical deposition or by means of physical deposition of a material with high cohesion and with subsequent rapid thermal annealing for agglomeration, thereby producing height variations of up to 20 μm. The height variations are in the region of the thickness of the active layer. The expression “material with high cohesion” is understood to mean substances whose interatomic or intermolecular bonding forces are sufficiently strong that clusters or agglomerates are formed.

For example, in one embodiment of the method a thin layer of silver is deposited onto the copper substrate surface. As a result of rapid thermal annealing, in particular flash lamp annealing, the silver layer agglomerates to form particles/drops/clusters, resulting in unstructured roughening of the copper foil. The foil can subsequently be further processed as normal.

The height variations thus produced allow a subsequently deposited active layer to be broken into regions of different size on the substrate thus modified. In this way, the good adhesion properties of the active layer with respect to the substrate remain, but the stress in the active layer can be significantly reduced.

The object is also achieved by a third method according to independent claim 7. The method for producing a silicon anode for lithium batteries, in which method an active layer of silicon is deposited on a substrate, preferably copper, said active layer subsequently being subjected to rapid thermal annealing, the active layer is structured into segments during the production of the active layer by means of photolithography and subsequent physical deposition, preferably sputtering or evaporation deposition, and annealing, preferably rapid thermal annealing.

In this embodiment for achieving the object, the substrate surface is not structured or roughened, but rather the active layer itself is structured.

In one embodiment of this method according to the invention, the active layer is structured into segments having a size of 10 μm to 5 mm. This has the advantage that an anode formed from the active layer thus produced is, in its entirety, stressed only locally and not over the entire area of the anode.

In another embodiment of the method according to the invention, the active layer is structured into segments, the distances of which from one another are 2 μm to 10 μm. The advantage is that, in addition to the reduction in the stresses in the active layer, local expansion of the active layer due to lithium intercalation during or before battery operation can be controlled and extensive action of stress on the foil is avoided.

The silicon anode produced by means of one of the methods according to the invention comprises a substrate, on which an active layer of silicon and/or silicon-based component is arranged, said active layer having a layer thickness of at least 1 μm to at most 20 μm, preferably at least 2 μm to 15 μm, particularly preferably at least 4 μm to 10 μm, and having an area coverage of greater than 85% and thus having a low porosity of 15% or less.

For sufficient battery capacity, a layer thickness in the range of at least 4 μm to 10 μm is to be preferred for use in battery production for an assumed storage density of 2000 mAh/g for silicon.

It is typical in the prior art that silicon particles surrounded by carbon and adhesives, so-called binders, are applied to a smooth surface, such that the layer has a defined porosity so that the silicon can expand without stress when lithiation occurs. Without the use of binders, for pure silicon layers there is only adhesion resulting from a roughened surface. This results in sufficient cavities in the layer construction in order to compensate for the stress when volume expansion occurs. According to the prior art, porosities of 15% to 80% are used. By means of the methods according to the invention, pure silicon anodes can be modified and prepared in such a way that, in the case of area coverage of greater than 85%, the silicon can nevertheless expand on the substrate without stress during the lithiation process and/or delithiation process without losing electrical contact with the substrate.

In the silicon anode according to the invention, the active layer is substantially formed of a portion of amorphous or semicrystalline silicon and/or a portion of silicide and/or a portion of a solid solution of one or more metals in silicon and/or a mixture of said portions. The different morphologically formed parts of the active layer have the advantage that there exist both a nanostructured silicon which can expand isotropically without structurally disintegrating and a stable conductive framework structure which permanently adjoins the amorphous silicon and which ensures steady electrical contact.

In one embodiment of the silicon anode produced according to the invention, the substrate is formed of copper, an alloy having copper, nickel, aluminum, carbon and/or steel.

It is advantageous to use the methods according to the invention for producing a silicon anode in a lithium-ion battery as claimed in the method claims.

It is also advantageous to install and use the silicon anode as claimed in claim 10 in a battery cell, in particular in a lithium-ion battery.

The battery cell in turn can advantageously be installed in a battery having at least one battery cell.

The invention is to be explained in more detail below on the basis of an exemplary embodiment.

The drawings show:

FIG. 1 exemplary construction and function of a lithium-ion cell during the discharging process;

FIG. 2 a) schematic illustration of meander formation in the layer stack due to the 3D volume expansion when lithium is intercalated; b) image of warping of a layer without the structuring according to the invention;

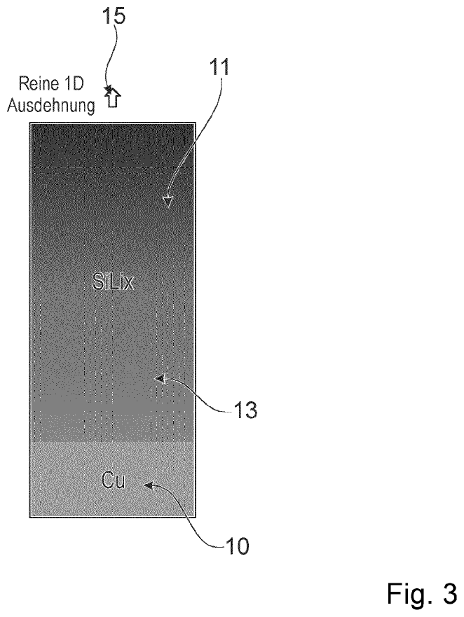

FIG. 3 forcing of one-dimensional expansion of the layer stack in a lithium-ion battery;

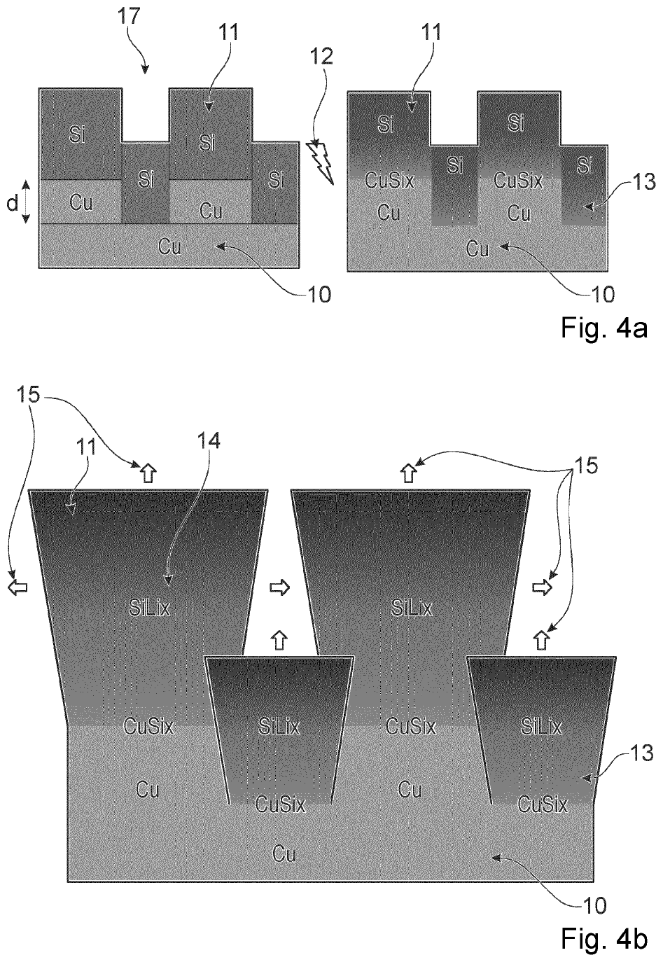

FIG. 4 schematic illustration of a prestructured substrate surface for reducing stresses in a layer stack for a lithium-ion battery according to a variant of the production method according to the invention, a) before Li intercalation, b) after lithium intercalation;

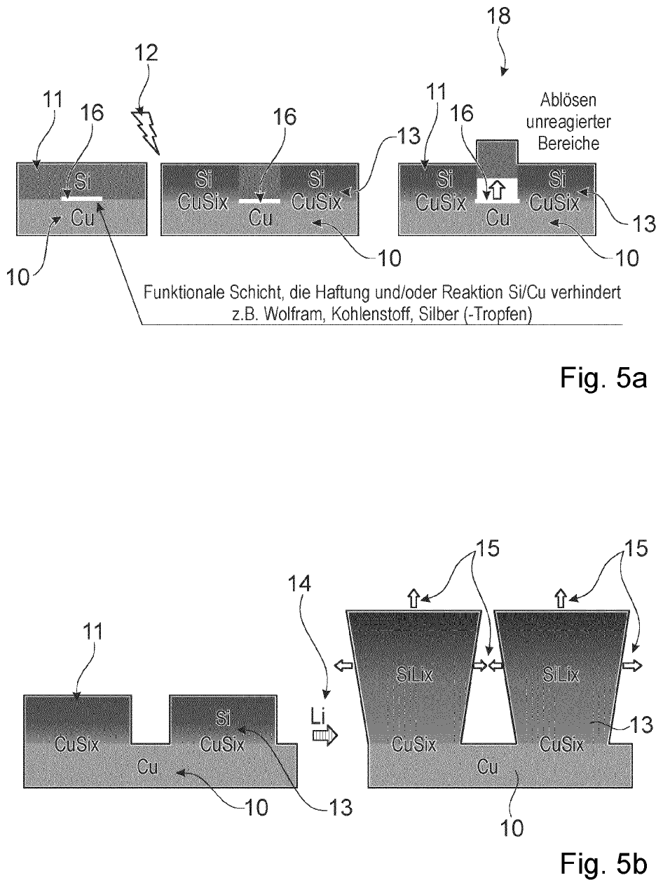

FIG. 5 schematic illustration of a structured active layer for reducing stresses in a layer stack for a lithium-ion battery according to a variant of the production method according to the invention, a) process of structuring the active layer, b) left: before Li intercalation, right: after lithium intercalation.

If the active layer 11 is applied directly to the current collector 2, 10 and is subjected to rapid thermal annealing 12, adhesion on the substrate/current collector 2, 10 is extremely high. As a result of the partly gradual stack construction of the silicon anodes, the active layer 11 is not pulverized; power contact is permanently maintained. However, because of the strong adhesion, the stress of the active layer 11 is transferred to the current collector 10, and said stress manifests itself in bulging of the foil after production. Here, corrugations of the current collector 2, 10 which are observed for the first time and which correspond to a meander structure would arise after battery operation due to the high volume expansion of the active material (FIG. 2).

The corrugation, i.e. the meandering, of the layer or the layer stack can be counteracted by forcing the layer construction into merely one-dimensional expansion by means of the measures mentioned below (FIG. 3). Suitable measures for this purpose are the use of a thicker or harder copper substrate 10 or precharging or pre-lithiation of the active layer 11 of silicon during production or the application of a rigid framework in the immediate proximity of the copper substrate 10 or sufficiently gradual construction in order to support the stiffness of the copper substrate 10 or the application of a sufficient pressure to the anode produced during the forming. The term “forming” is understood to mean the first charging and discharging of a completed battery cell. A prerequisite for these options is the use of the rapid thermal annealing 12 by means of flash lamp or laser during the production of the layer stack in order to ensure sufficiently strong adhesion of the active layer 11 on the substrate 10. Without this rapid thermal annealing 12, the active layer 11 would simply become detached from the substrate 10.

Another means of countering the meandering of the layer stack of a silicon anode for lithium-ion batteries is the prestructuring of the current collector, i.e. the copper substrate 10, resulting in segmentation of the active layer 11, said segmentation breaking up and controlling the stress in the area of the anode (FIG. 4). FIG. 4a shows a schematic illustration of a structured substrate surface 10 in which the surface has been microscopically roughened/prestructured. This can be carried out in an ordered way, for example by means of rolling, embossing, stamping or lithography. In this way, height variations in the range of 400 nm to 10 μm can be achieved. The structuring can also be carried out in an unordered way, for example by means of brushing or etching or by means of galvanic deposition or agglomeration of particles on the copper substrate surface 10 before the deposition of silicon 11. It is advantageous that the structuring of the substrate surface is directly mapped to the structuring of the active layer.

When lithium 14 is intercalated into a layer construction structured in such a way, the Si layer 11 expands in a plurality of planes 15 which have formed as a result of the structuring (FIG. 4b). As a result, in contrast to a monolithically constructed layer, the total stress in the layer stack is broken up and dissipated, so that warping (meander) no longer occurs in the layer stack.

This for the first time provides a possible solution for reducing stress on the current collector 2, 10 in stack constructions for silicon anodes which were treated and produced with rapid thermal annealing 12.

FIG. 5a shows a schematic illustration of a structured active layer 11 which has been/can be produced in accordance with the method according to the invention as claimed in claim 7, wherein the surface has been/is microscopically roughened. According to the invention, this can be accomplished, for example, by applying a functional layer 16 which impedes adhesion and/or reaction between silicon 11 and copper 10. A suitable functional layer 16 can be composed of, for example, tungsten, carbon, or silver (droplets). In the regions without reaction between Si and the functional layer 16, the Si 11 is detached, and a structured active layer 18 of Si remains. This layer is deposited onto the substrate 10 (copper) in some regions by means of photolithography and subsequent physical deposition, and thereafter the active layer 11 of silicon is deposited. The expression “in some regions” means that the functional layer 16 is not applied to the entire surface of the copper substrate 10. In the regions in which the adhesion of Si to Cu is prevented by the functional layer 16, the Si is subsequently detached in the production process and a structured active layer 18 in the layer stack for a lithium-ion battery is retained.

When lithium 14 is intercalated into a layer construction structured in such a way, the Si layer 11 can expand 15 both in the vertical direction and in the horizontal direction (FIG. 5b). As a result, in contrast to an unstructured layer construction, the total stress in the layer stack is broken up and dissipated, so that warping (meander) in the layer stack no longer occurs.

Both the structuring of the substrate surface and the structuring of the active layer advantageously reduce stress of the layer construction and at the same time also greatly reduce the microscopic detachment of active material for battery operation.

### LIST OF REFERENCE SIGNS

1 Lithium-ion battery
2 Collector on anode side
3 Solid electrolyte interphase (SEI)
4 Electrolyte
5 Separator
6 Conductive intermediate phase
7 Cathode, positive electrode
8 Collector on cathode side
9 Anode, negative electrode
10 Copper substrate
11 Active layer
12 Rapid thermal annealing, e.g. flash lamp annealing
13 Reaction region after rapid thermal annealing between substrate and active layer
14 Lithium intercalation
15 Expansion directions after lithium intercalation
16 Functional layer applied in some regions
17 Structured substrate surface
18 Structured active layer

1. A method for producing a silicon anode for lithium batteries, in which method an active layer of silicon is deposited on a substrate, preferably copper, said active layer subsequently being subjected to rapid thermal annealing, characterized in that a substrate surface is structured by means of a process before the active layer is applied.

2. The method as claimed in claim 1, characterized in that the substrate surface is structured by means of a laser.

3. The method as claimed in claim 1, characterized in that the substrate surface is structured by means of embossing, rolling or stamping, thereby creating height variations in the region of the thickness of the active layer of up to 20 μm.

4. The method as claimed in claim 1, characterized in that the substrate surface is structured by means of photolithography and subsequent physical deposition, preferably by sputtering or evaporation.

5. A method for producing a silicon anode for lithium batteries, in which method an active layer of silicon is deposited on a substrate, preferably copper, said active layer subsequently being subjected to rapid thermal annealing, characterized in that the substrate surface and/or active layer is modified in an unstructured way by means of a process.

6. The method as claimed in claim 5, characterized in that the unstructured modification is carried out by means of rapid thermal annealing or by means of etching or by means of chemical deposition or by means of physical deposition of a material with high cohesion and with subsequent rapid thermal annealing for agglomeration, thereby creating height variations in the range of the thickness of the active layer of up to 20 μm.

7. A method for producing a silicon anode for lithium batteries, in which method an active layer of silicon is deposited on a substrate, preferably copper, said active layer subsequently being subjected to rapid thermal annealing, characterized in that the active layer is structured into segments during the production of the active layer by means of photolithography and subsequent physical deposition, preferably by sputtering or evaporation, and annealing, preferably rapid thermal annealing.

8. The method as claimed in claim 7, characterized in that the active layer is structured into segments having a size of 10 μm to 5 mm.

9. The method as claimed in claim 7, characterized in that the active layer is structured into segments, the distances of which from one another are 2 μm to 10 μm.

10. A silicon anode for a lithium-ion battery produced according to one of the methods as claimed in claim 1, characterized in that the silicon anode comprises a substrate, on which an active layer of silicon is arranged, said active layer having a layer thickness of at least 1 μm to at most 20 μm, preferably at least 2 μm to 15 μm, particularly preferably at least 4 μm to 10 μm, and having an area coverage of greater than 85%.

11. The silicon anode as claimed in claim 10, characterized in that the active layer is substantially formed of a portion of amorphous or semicrystalline silicon and/or a portion of silicide and/or a portion of a solid solution of one or more metals in silicon and/or a mixture of said portions.

12. The silicon anode as claimed in claim 10, characterized in that the substrate is formed of copper, an alloy having copper, nickel, aluminum, carbon and/or steel.

13. The use of the methods for producing a silicon anode in a lithium-ion battery as claim 1.

14. A battery cell, in particular a lithium-ion cell, comprising a silicon anode as claimed in claim 10.

15. A battery, in particular a lithium-ion battery, comprising at least one battery cell as claimed in claim 14.
